(19) United States
(12) Patent Application Publication
(10) Pub. No.: US 2011/0167385 A1
(43) Pub. Date: Jul. 7, 2011

(54) PROCESSING OF DATA FOR IMPROVED DISPLAY

(75) Inventors: Bénédicte Charrue, Le Vesinet (FR); Xavier Bringue, La Garenne (FR)

(73) Assignee: France Telecom, Paris (FR)

(21) Appl. No.: 12/985,499

(22) Filed: Jan. 6, 2011

(30) Foreign Application Priority Data
Jan. 6, 2010 (FR) 10 50054

(51) Int. Cl. G06F 3/048

(52) U.S. Cl. 715/825; 715/838

(57) ABSTRACT

A method and system relate to the processing of data in order to display thumbnails, when commanded by a user, containing information concerning multimedia content, for example television programs, having respective durations and available via a plurality of respective sources and at respective times. The thumbnails are distributed across a screen: by time of availability along a first axis, and by source along a second axis distinct from the first axis. In particular, the apparent dimensions of the thumbnails are equal and independent of the content duration.

### CROSS-REFERENCE TO RELATED PATENT APPLICATION

This application claims the benefit of French Patent Application No. 10 50054, filed on Jan. 6, 2010, in the French Institute of Industrial Property, the entire contents of which is incorporated herein by reference.

### BACKGROUND

This invention relates to a processing of data for display on a screen of information concerning multimedia content, particularly television programs in Electronic Program Guides (EPG), and more generally multimedia content (video, images, sounds, or other content) shared with third parties for example.

Known electronic program guides displayed on a television screen are text-based. The text providing information about a program appears inside a box extending across a portion of the screen that is proportional to the length of the program. For a short program, the box provided for displaying information on the screen is very small. For example, FIG. 3 in the prior art document WO-2009/055273 shows a box denoted 310 which, if it were to include more information, would require smaller characters than in the box denoted 340. The resulting disadvantage to a user is the difficulty reading the text due to the reduced size of the characters.

In current practice in known EPG guides, program titles cannot always be displayed in their entirety and are often truncated. This reduces the information provided about the programs.

The program guide may therefore be difficult to read because of how the display of data for televised programs of variable durations is managed, as short programs have very little room.

### SUMMARY

Various embodiments of the invention provide a method, implemented by a device, for processing data in order to display information, when commanded by a user, concerning multimedia content items of respective durations and available via a plurality of respective sources and at respective times, such as a television program. This information is presented in the form of thumbnails distributed across a screen:
by time of availability along a first axis, and
by source along a second axis distinct from the first axis.

In the sense of various embodiments, the apparent dimensions of the thumbnails are equal and independent of the content duration.

A user can thus quickly obtain a general view of the content available at any given moment from a large number of sources.

Preferably, all of these thumbnails are presented in the form of a matrix consisting of cells which are all of the same size.

xxx Each element in the matrix corresponds to a thumbnail. In particular, a row/column of the matrix which has a fixed position in the matrix, for example a middle row/column that is horizontal or vertical, contains thumbnails representing content available at a given reference time via the different sources represented in the matrix. This reference time may correspond to the current time, for example when the user accesses the program guide, or may be chosen by the user, for example if he wants to display past or future programs. The reference time may therefore also correspond to the time (future or past) when the particular content for the thumbnail the user has selected in the matrix is available, as will be seen in the following example embodiment.

The device preferably comprises a means for modifying the previously mentioned reference time, and when this reference time is modified by a command from the user, the device orders the thumbnails of the matrix to be updated such that the previously mentioned fixed position row/column comprises thumbnails concerning the content broadcast at the modified reference time.

In such an embodiment, the device comprises a means for selecting a thumbnail in the matrix, and when another thumbnail is selected by a command from the user, the device orders the thumbnails of the matrix to be updated such that the previously mentioned fixed position row/column comprises the selected thumbnail and the thumbnails concerning the content items being broadcast at a time when the content associated with the selected thumbnail is available.

This novel display method allows the user to obtain information about any content item and about the other content broadcast simultaneously with said any content item, simply by selecting another thumbnail. Via the mechanism of synchronizing thumbnails in a row/column relative to a reference time corresponding to a time when the content associated with these thumbnails is available, the user has access to information about the temporal synchronization between such content with no need to use a common time axis for the different sources. This eliminates the display constraints resulting from the use of a common linear time axis for the different sources: it is no longer necessary to provide a thumbnail size representative of the duration of a content item and adapted to this common time axis. This improves the readability of the thumbnail content and allows displaying a sufficient number of thumbnails so that the thumbnails of the content items preceding and following the currently broadcast content items are always visible no matter how large or small the screen.

In one embodiment, each matrix element corresponds to a different content item.

Such an embodiment allows a clear, structured, and homogeneous representation of all the content items. The user quickly sees the information about all content available at a given time from a given number of sources, due to the fact that each cell represents a different content item, with the same thumbnail dimensions for all content items independently of their duration.

In addition, in one advantageous embodiment, the user can display certain information concerning the content, selected according to criteria that he can choose. In such an embodiment, said device allows:
selecting content according to at least one criterion, and
controlling the display of thumbnails in the matrix by displaying the selected content differently than the unselected content.

The chosen criterion can, for example, be the availability period of a content item, the content genre (televised news, movie, documentary, or other content), the television channel broadcasting the content, or other criteria. Of course, it is possible to choose more than one selection criterion at a time, for example all movies broadcast in the evening.

As described below with reference to FIG. 4, the thumbnails for content not meeting the selection criteria are preferably displayed with less detailed information (or even no information) than those for content meeting the selection criteria.

In one particular embodiment, the device receives metadata concerning each content item and said search can then be performed using at least one keyword selected in the metadata received. For example, an actor's name in a movie can be a keyword used to select movies in which the actor has a role. Similarly, the content genre (drama, comedy, sci fi, children's, etc.) can also be selected by keyword.

More generally, various embodiments of the invention improves the usability for users of the tool consisting of such a user interface for content selection.

### BRIEF DESCRIPTION OF THE DRAWINGS

Other features and advantages will be apparent from reading the following description, with reference to the attached drawings in which:

FIG. 1 represents an example of a possible context for an application of an embodiment

FIG. 2 illustrates one possible embodiment of the display of information concerning content from different sources;

FIGS. 3a and 3b schematically illustrate the respective matrices of thumbnails associated with two distinct given times, illustrating an update to the thumbnails when the time is modified by a user command; and

FIG. 4 illustrates the matrix in FIG. 2 which has been filtered to display only the selected information about the content.

### DETAILED DESCRIPTION

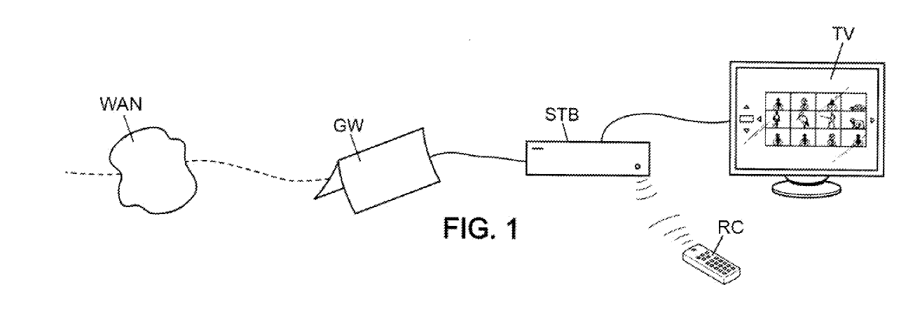

We will begin by referring to FIG. 1, in which information concerning multimedia content is displayed as a matrix of thumbnails on the screen of a television set TV in the example represented. This set is connected to a terminal STB (for Set Top Box). This terminal STB can receive the data for the thumbnail display via a gateway GW connected to a wide area network WAN (or via a satellite link or cable). In particular, a user can control the display of the thumbnail matrix on the screen TV, for example by using a remote control RC for the terminal STB.

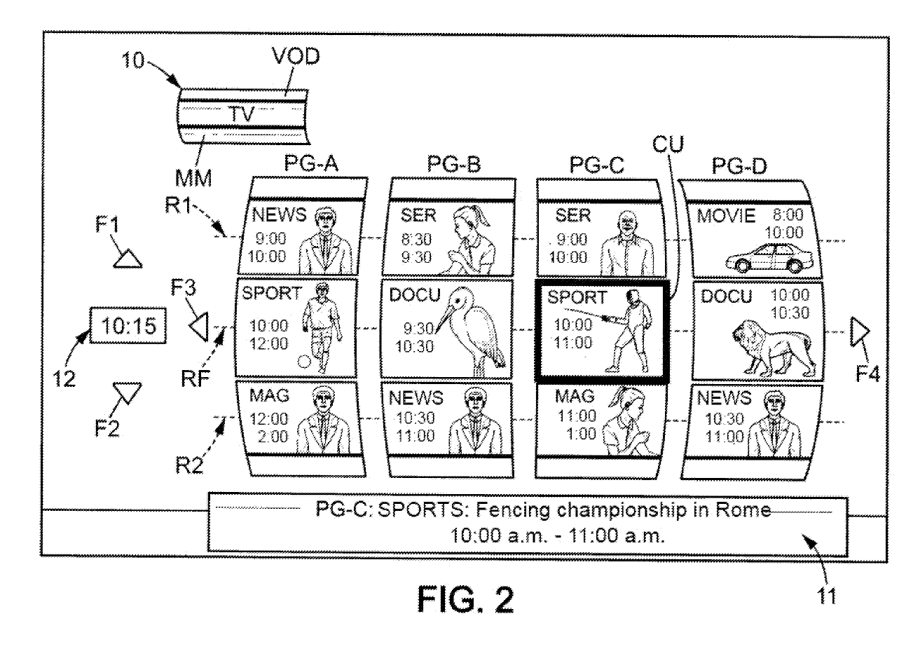

Now we will refer to FIG. 2 and describe in more detail the display of information on the screen. The terminal STB advantageously controls the display of a menu for selecting the type of content 10. It is thus possible to choose to display thumbnails concerning the content of a program grid in an EPG guide (denoted TV in FIG. 2), or information concerning multimedia content that is shared with third parties (denoted MM), or information concerning all other multimedia content, such as videos for a Video On Demand (VOD) application.

In the example represented, the selected multimedia content items correspond to programs from sources PG-A, PG-B, PG-C, and PG-D (typically television channels for an EPG guide). Each column in the thumbnail matrix is associated with a source (the program channel PG-A, the program channel PG-B, etc.), while a row in the matrix, such as the middle row RF, is associated with a given time (10:15 in the box denoted 12 in FIG. 2).

One will note in FIG. 2 that the information for all programs on the same channel (three successive programs in the example represented) appears in respective thumbnails of the same apparent dimensions, even when their respective program lengths are different. Thus, unlike known EPG program guides, no use is made here of a linear representation of the time axis. All the cells of the matrix are of the same size, with each column comprising a list of programs successively broadcast on a channel, independently of the actual duration of these programs. In one row, particularly the middle row RF in FIG. 2, the programs scheduled at a given time (indicated in the box 12) are represented. Each matrix element is thus displayed as a thumbnail, appearing inside a cell of the matrix and containing the entire title of the program, the start and end time, and possibly the program genre (news, series, movie, sports program, documentary, magazine, etc.), as well as an animated or fixed image, as will be seen below.

The expression “thumbnails of the same apparent dimensions” covers the various methods for representing a matrix using rectangular cells of identical dimensions, inside of which these thumbnails are displayed. Such a matrix can be represented in two or three dimensions: as a two-dimensional matrix with rectangular cells of substantially the same size, or as a projection of such a matrix onto a two- or three-dimensional surface, such as a trapezoid, a cylinder, or a sphere, represented with or without a perspective effect. As an example, FIG. 2 represents a two-dimensional matrix with rectangular cells of the same size, projected onto a cylinder (front view), which gives the impression that the matrix is rotating around a cylinder. Due to the deformation caused by the projection of the two-dimensional matrix with rectangular cells of the same size onto a two- or three-dimensional surface, the cells may not have exactly the same shape or size after projection. In addition, the thumbnails displayed inside the cells of the matrix may be non-rectangular in shape, oval or elliptical for example, and if applicable are projected onto a surface in the same manner as the matrix.

Again referring to FIG. 2, the time displayed in the box 12 serves as a reference time for the display of the matrix thumbnails: no matter what the value of said time, the middle row RF comprises the thumbnails for the content broadcast at that reference time via the different sources represented in the matrix. With this in mind, the time displayed in the box 12 is referred to here as the “reference time”.

In the representation in FIG. 2, the X axis represents the different sources (PG-A, PG-B, etc.) and the y axis represents the time (succession of programs over time from a given source). In one variant, these two axes can be inverted, with the succession of programs on the same channel represented in the same row and the content available on the different channels at a given time represented in the same column (fixed position).

The user makes use of the arrows F1 to F4 to order changes to the program schedule. These arrows respectively correspond to pressing a button on a remote control representing the “up”, “down”, “left”, or “right” arrows. Any other control method simulating a displacement in one of these four directions can also be envisaged.

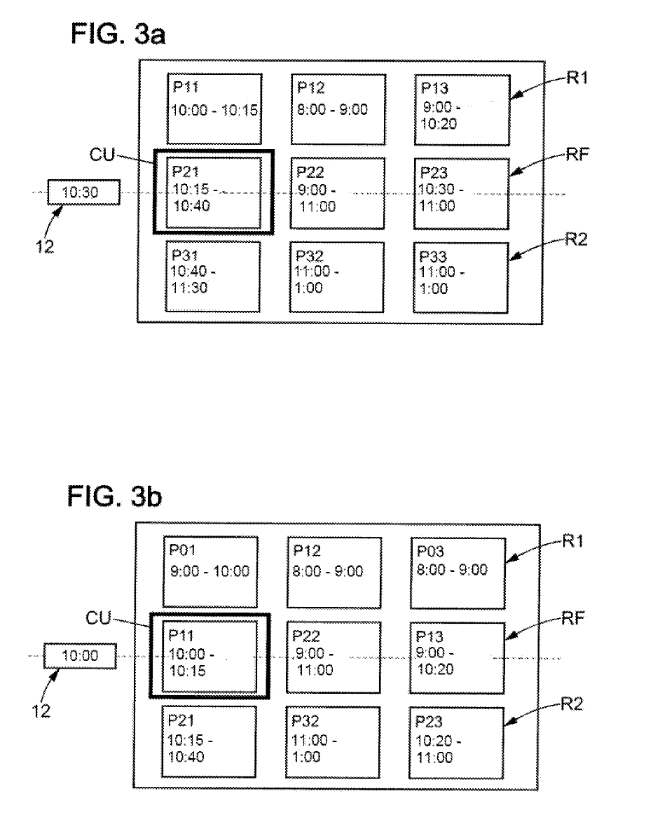

The arrows F1 and F2 allow the user to navigate between different times in two different browsing modes:
in a first navigation mode, the user navigates between different times by modifying (incrementing or decrementing) the reference time in the box 12;
in a second navigation mode, the user navigates between different times by selecting one thumbnail and then another in the matrix: this allows selecting content broadcast before or after the currently selected content via the same source as the currently selected content; this second mode of navigation will be described in more detail with reference to FIGS. 3a and 3b.

The user can switch from the first mode of navigation to the second mode of navigation or vice versa by modifying the focus, meaning the user interface element which is currently selected (represented by the curser CU in the example in FIG. 2):
either the focus is on the box 12, and in this case, the current mode of navigation is the first mode of navigation;
or the focus is on a thumbnail in the matrix (meaning that this thumbnail is selected, as represented in FIG. 2), and in this case, the current mode of navigation is the second mode of navigation.

The change of focus is done, for example, by activating a predefined button on a remote control, or by a combination of buttons, or by any other appropriate method.

In the first mode of navigation, the arrows F1 and F2 allow the user to navigate between different times such that the middle row RF of the matrix represented in FIG. 2 indicates the programs available at the currently selected time, meaning the reference time indicated in the box 12. Thus the middle row RF of the matrix corresponds to the fixed position row/column RF mentioned in the above description. For example, incrementing (or decrementing) using arrow F2 (or F1) can advance (or move back) the time indicated in the box 12 by 15 minutes, or more if the user so chooses (several hours or a day for example).

If changing the reference time indicated in the box 12, the thumbnails in rows other than the middle row RF are also updated such that:
each thumbnail situated in a row R1 preceding the middle row RF and in a column comprising the content items issuing from a source, contains information about a content item available via said source prior to the content item issuing from the same said source for which the thumbnail appears in the middle row RF, and
each thumbnail situated in a row R2 following the middle row RF and in a column comprising the content items issuing from a source, contains information about a content item available via said source after the content item issuing from the same said source for which the thumbnail appears in the middle row RF.

Thus, in each column of the matrix associated with a given source, for any reference time displayed in the box 12 and thumbnails displayed in the middle row RF, the thumbnails in this column represent a list of content available via this source, ordered from earliest to latest availability.

In addition, the arrows F3 and F4 allow the user to navigate between the different sources (for example in order to access subsequent program channels PG-E, PG-F, etc.). In the example represented, the content thumbnails are represented on a horizontal axis (arrows F3 and F4) as a function of the content sources and along a vertical axis (arrows F1 and F2) as a function of the time. As indicated above, in one variant, the thumbnails can be distributed in different rows, each associated with a content source.

A more detailed description of the contents of the displayed matrix as a function of the reference time selected in the box 12 in FIG. 2 appears below. In addition to the navigation arrows F3 and F4 for accessing different content sources, there are navigation arrows F1 and F2 for incrementing or decrementing the reference time displayed in the box 12. In particular, a menu may be provided for the user to specify the amount to increment or decrement the selected time when using the arrows F1 and F2. For example, the increment/decrement amount can be chosen to be several hours in order to display content available within a given window of time, for example in the evening, or a day in order to display the content available on a given date, such as the next day or the same day the following week, or some other amount.

In one embodiment, when the user accesses the program guide as represented in FIG. 2, the currently selected thumbnail corresponds to the program which the user was watching at the moment the display of the guide was requested. By default, the box 12 indicates the current time (10:15 in the example represented).

The currently selected thumbnail is for example encircled by a cursor CU, or highlighted, or displayed in a manner different from the other thumbnails. It is assumed in the following description that a cursor CU is used to point to the currently selected thumbnail. The cursor CU is initially positioned on one of the thumbnails in the fixed position row/column RF (middle row of the matrix in the example in FIG. 2), and in the column corresponding to the television channel that the user is watching (for example the program PG-C in FIG. 2). The user may then cause the cursor to move from one thumbnail to another in the matrix. In practice, the terminal STB controls the display of the cursor, as well as an apparent displacement of the cursor from one thumbnail to another in the fixed position row/column RF.

For example, the user may activate buttons corresponding to the up-down-left-right arrows on the remote control RC in order to position the cursor CU where he wants it in the matrix. He can also exit the matrix by continuing to activate these buttons in order to reach the arrows F1, F2, F3, and F4. He can also activate the “OK” button on his remote control, for example, to select a content item.

The terminal also controls the display of additional information, outside the matrix and inside the box 11 in FIG. 2, concerning the content for the thumbnail indicated by the cursor CU. For example, if each thumbnail provides information about the content genre (movie, documentary, series, sports event, news, magazine, or other content), title, as well as the program start and end time, the box 11 can provide additional details such as a brief program summary, specifically the type of movie and its actors, or the type of documentary, or an indication of the sporting event, etc. By using the cursor CU to navigate in this manner from one thumbnail to another, the user can read about the content indicated by the thumbnail selected by the cursor.

In the example represented in FIG. 2, the matrix contains three rows:
the middle row RF associated with the time indicated in the box 12,
as well as a row of content items which were each available via a content source prior to the content item in the middle row RF available via the same said source, this row being denoted R1 in FIG. 2, and
a row of content items each available via a content source later than the content item in the middle row RF available via the same said source, denoted R2 in FIG. 2.

By considering a vertical time axis where later times are at the bottom, the row R1 precedes the middle row RF and the row R2 succeeds the middle row RF. One can see by referring to FIG. 2 that the content items from each source succeed each other in time, from row R1 to row R2, and this is true for each column. Also, in the middle row, the thumbnails for all the content items indicate time slots which all include the time displayed in the box 12. On the other hand, for rows other than the middle row RF, for example row R1 or row R2, it is possible that content items in the same row may be scheduled in time slots that do not overlap. This is the case for the content from sources PG-A and PG-B in row R2, for example. The explanation for this observation is detailed below, with reference to FIGS. 3a and 3b.

This description will now refer to FIGS. 3a and 3b while detailing the second mode of navigation.

This second mode of navigation allows selecting any thumbnail in the matrix and modifying this selection. Such a modification has the effect of incrementing or decrementing the reference time indicated in the box 12, as described in detail below.

A thumbnail is selected by means of the arrows F1 to F4, in other words by activating the remote control buttons representing the “up”, “down”, “right”, and “left” arrows.

In FIG. 3a, the current time in the box 12 is 10:30 a.m. Therefore the display shows programs P21 to P23 broadcast during the time slots that include the current time 10:30 a.m. in the middle row RF. Before issuing the command to display the EPG guide, the user was watching the program P21. The cursor CU is therefore positioned by default over this program P21 when the EPG guide is displayed.

The user then presses the “up” arrow on his remote control (arrow F1) to indicate that he wants to select the thumbnail corresponding to the previous program P11 (row R1) on the same channel that is broadcasting the program for the currently selected thumbnail.

Now with reference to FIG. 3b, the reference time associated with the middle row RF, which is indicated in the box 12, is now a time during which the program for the selected thumbnail is available, for example the start time for the program P11 of the thumbnail now indicated by the cursor CU, which is 10 a.m. Thus the middle row RF displays the thumbnails for programs broadcast via the different channels represented in the matrix at the now modified reference time. The thumbnails for the rows R1 and R2 of the matrix are also updated in the same manner as in the first mode of navigation, unless, in the second mode of navigation, the reference time indicated in the box 12 is a time at which the selected program is available. This time defaults in the described example to the selected program's start time.

One will note that the cursor CU, when the user moves it around in the matrix, is still located in the middle row RF, because each time the user issues a command to view information about a program after or before the given time in box 12, the thumbnail for this program appears in the middle row RF and is indicated by the cursor CU. The time given in box 12 becomes the start time for the program's broadcast. The thumbnails are accordingly updated with:
a synchronization of the thumbnails in the middle row RF concerning content for which the broadcast windows include the given time in box 12, and
an adjustment to the thumbnails in the preceding row R1 and the subsequent row R2, with the preceding row now including the thumbnails for each content item broadcast before a content item in the middle row RF and in the same column, and with the next row now including the thumbnails for each content item broadcast after a content item in the middle row RF and in the same column.

Thus, in the example represented, a new thumbnail for a program P01 preceding the program P11 is displayed in the first row R1. Similarly, the thumbnail for the program P03 which precedes the program P13 broadcast at the given time 10 a.m. is displayed in the row R1. However, the program P22 which is broadcast at the given time 10 a.m. remains in the same position in the middle row RF, and the thumbnail for the program P12 also remains in the same position in the row R1 because this program P12 immediately precedes the program P22. Similarly, the thumbnail for the program P21, which is scheduled to be broadcast after the program P11, replaces the thumbnail for the program P31 in the row R2, and the thumbnail for the program P23 also replaces the program P33 in the row R2.

It can be seen that the display of thumbnails in the fixed position row/column RF is specific to the content items broadcast within time slots which include the given time indicated in the box 12. However, each thumbnail in the first row R1 contains information about an available content item (for example the program P01) broadcast before a content item issuing from the same source (the program P11) and for which the thumbnail appears in the fixed position row RF. Similarly, each thumbnail (for example for the program P21) in the second row R2 contains information about an available content item (the program P21) broadcast after a content item (the program P11) issuing from the same source and for which the thumbnail appears in the middle row RF. Content items may therefore appear in the same row R1 or R2, even if the broadcast of such content is (or was) scheduled within windows of time which do not overlap.

Thus, when the user selects another thumbnail, whether by using arrows F1, F2 to select a program preceding or following the currently selected program, or by using the arrows F3, F4 to select another thumbnail in the middle row RF or in other words to select a program broadcast on another channel which is at least partially simultaneous with the currently selected program, all the thumbnails are dynamically updated relative to a new reference time defined as being a time at which the newly selected program is available. By default, the start time for the broadcast of the newly selected program is chosen as the new reference time. This new time is displayed in the box 12 and is updated whenever another thumbnail is selected.

FIG. 2 describes in more detail the images contained in the thumbnails. The images represented in each thumbnail in FIG. 2 can be, in one example embodiment:
animated images in the middle row RF, if the middle row is associated with a current time (for example the current hour); and
the images in rows R1 and R2 are fixed in this embodiment.

In this embodiment, the terminal STB accesses animated image data in the stream of multimedia data which includes metadata, in order to display a preview for programs currently being broadcast. For example, certain current functionalities allow processing a data stream into several separate streams of images. It is then possible to choose streams to be displayed simultaneously on the screen, with selected display sizes and positions. Such streams are known as PIP for Picture in Picture. This technique offers the possibility of displaying a real-time, interactive preview representation in the fixed position row/column RF, without degrading the display capacities or increasing the response time of the terminal STB when changing channels (“zapping”).

Within the metadata, the terminal also receives data concerning the content, such as the title of a show, its start time, its end time, and its genre, as well as image data (generally fixed images) used to display an image specific to the content item such as an image characteristic of a program, a movie poster, or some other image. The images in the thumbnails for the rows R1 and R2 can correspond to these images pulled from the metadata.

One advantageous embodiment proposes a tool for searching the wealth of televised content.

This tool consists of a multicriteria search engine, basing the search on the descriptive data for the content which are used to enrich the contents of the displayed thumbnails. These descriptive data are, for example, the metadata received by the device in order to control the display of thumbnails. This embodiment offers a search by values or appropriate keywords chosen by the user, as described below.

As the search for content that satisfies the filter criteria chosen by the user is done based on the provided metadata, any search based on information provided by the metadata is possible (date, category, genre, name, program duration, channel, or other information).

The filter criteria are independent of each other and can be combined for a multicriteria search. It is, however, possible to specify only one filter criterion, or to do a very specific search using all available types of filters (which of course restricts the number of programs shown in the program guide).

It is possible to have a “customized” filter criterion, where the user enters a name (of an actor, a movie, etc.) or a keyword or a value of his choice, or a predefined filter criterion as described below. In the example provided below, the proposed predefined filter criteria are relevant and effective for quickly finding programs to watch or record.

A first type of filter concerns the broadcast period for content and allows filtering by the following examples of predefined criteria: all, now, tonight, tomorrow, later dates, etc.

A second type of filter concerns the content category and allows filtering by the following examples of predefined criteria: all, entertainment, movie, series, news, sports, documentary, children's, music, etc.

A third type of filter concerns the content type and allows filtering by the following predefined criteria: all, action, comedy, family, sci fi, horror, etc.

A fourth type of filter concerns the television channel that broadcasts the content and allows filtering by the following predefined criteria: all, favorites, high definition, public/private, etc.

These criteria are provided as examples and this is not an exhaustive list.

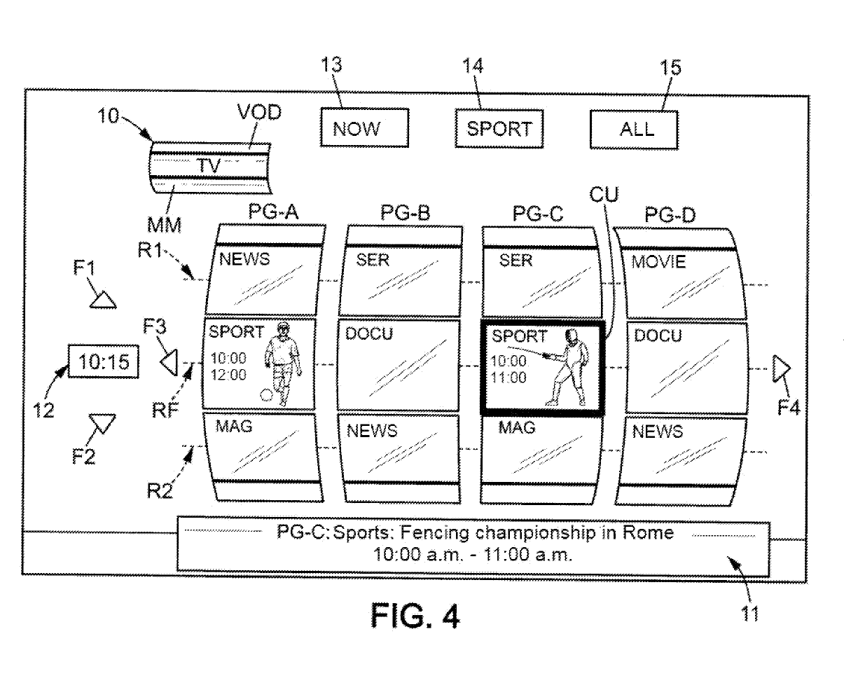

With reference to FIG. 4, the user is offered a filtering means 13, 14, 15, in the form of “buttons” containing the title of the type of filter associated with each button. Thus, in the general representation of the program guide in FIG. 4, a bar of filtering buttons situated for example above the matrix of the program guide, allows filtering all the available programs according to filter criteria chosen by the user. When the user clicks on a filtering button, the various predefined filter criteria for the type of filter associated with this button appear as a drop-down list or a circular list, each item in the list being a filter criterion that the user can select.

After each selection of a filter criterion by the user, the complete matrix is still displayed but the thumbnails for content meeting the filter criteria appear differently than the thumbnails for content not meeting these criteria. The latter are represented by thumbnails of the same dimensions, but are grayed out for example, without images, and without details on the content or with fewer details compared to the content meeting the filter criteria. The only information that these grayed-out thumbnails show is, for example, the type of content (series, news, movie, etc.). In one variant embodiment, the thumbnails for content not meeting the filter criteria are empty of any information: these thumbnails are expressed as empty cells in the matrix, although still of the same size as cells showing information about a content item meeting the filter criteria.

Such an embodiment allows the user to distinguish quickly and easily the content meeting the filter criteria he selected.

Navigating in the program guide remains unchanged, as does the previously described principle of displaying and selecting content.

Thus, by pressing a button on the remote control RC, the user places the cursor CU over the first filter button, for example the button 13 containing the text “when”, for a first type of filtering. The list of criteria associated with the filter button 13 contains, for example, the predefined filter criteria “now”, “tomorrow”, “evening”, etc. The user selects the desired filter criterion, for example “tomorrow”, using the up and down navigation arrows on his remote control.

When the user then confirms his selection, the guide is instantly updated to reflect the chosen filter criterion. The name of the chosen filter criterion, e.g. “tomorrow”, is then displayed under or in the “when” filter button.

Next, the user can move the cursor to filter the content by a second type of filtering, for example by “category”, using filter button 14. The list of associated criteria contains, for example, the following predefined filter criteria: “all”, “news”, “movie”, “sports”, “documentary”, etc. The user can select a predefined filter criterion appearing in the list or enter a keyword defining this filter criterion, e.g. the “sports” category.

He can then advance to the next filter button 15 for another type of filtering, for example by the channel that broadcasts a particular show. The list of filter criteria associated with this button contains, for example, the following predefined filtration criteria: “all” channels, “favorites”, “high definition”, etc. After the user selects a filter criterion, one or more columns in the matrix are replaced by new columns where necessary, so that the matrix only contains columns concerning the channels that meet the filter criterion selected via the filter button 15.

FIG. 4 illustrates an example of how the program guide appears after searching by the three filter criteria “now”, “sports”, and “all” channels.

In one embodiment, the performed selection is erased (or reset) as soon as the user exits the EPG guide. He then must do a new search if he opens the EPG guide at a later time if the selection criteria are not stored.

The great diversity of audiovisual programs broadcast by an ever-increasing number of channels provides the user with a considerable wealth of programs to watch. However, there is the problem of choosing from among these programs. In the embodiment of the invention, the easy and rapid selection of content from among a multitude of content choices at a given time provides an advantage by showing a matrix with only a selection of thumbnails for the selected content. However, such filtering (for example by keyword in the metadata) in order to display selected programs in an EPG guide can itself be the subject of separate protection, independent of a representation of thumbnails of the same dimensions.

The invention is not limited to the example embodiment described above; it extends to other variants.

Programs which immediately succeed one another in time were described above with reference to FIG. 2 or to FIGS. 3a and 3b. In one variant, it is possible that the displayed programs do not immediately follow one another, for example when a short advertisement is inserted between two programs which are each of long duration. Thus, the second program (which follows the first) may be scheduled to be shown ten minutes later than the end of the first program. The display of the corresponding thumbnails can advantageously take such a delay into account.

Matrices with three rows were represented in the examples in FIGS. 2, 3a and 3b. However, in possible variant embodiments, a matrix of more than three rows can be displayed, or one that only contains two rows (for example a row for the current time and a row for subsequent programs). However, displaying information about past shows is advantageous because it is now possible to view a show that has already ended (“catch up” function) or to view a show from the start even if it has already begun (“start over” function).

A device such as a Set Top Box type of terminal for processing the data to be displayed on the screen of the TV set was described above with reference to FIG. 1. Of course, as a variant, the invention can be implemented in other types of environments. A device such as a PC computer, or a mobile terminal, can implement embodiments of the invention and display on a screen connected to the computer or on the terminal screen. Similarly, the mode of navigation within the guide by using a remote control RC was described above as an example, but in a variant this can be achieved by means of a gesture recognition interface, a mobile telephone, or any other control means.

Various embodiments of the invention therefore concerns a device, in general, comprising a means of processing data for display.

For this purpose, such a processing means may be controlled by the execution of a computer program comprising instructions for implementing the method described above, when said program is executed by a processor.

Various embodiments of the invention also relate to a system, as represented as an example in FIG. 1, comprising:
a device TV comprising a display screen, and
a device (denoted STB in the example in FIG. 1) comprising a means for processing data for the display, upon receiving a command from a user, of thumbnails containing information concerning multimedia content having respective durations and available via a plurality of respective sources and at respective times, these thumbnails being distributed across the screen:
   by time of availability along a first axis, and
   by source along a second axis distinct from the first axis.

In particular, the apparent dimensions of the displayed thumbnails are equal and independent of the content duration.

1. A method, implemented by a device, for processing data in order to display thumbnails, when commanded by a user, containing information concerning multimedia content items having respective durations and available via a plurality of respective sources and at respective times, the method comprising:
distributing said thumbnails across a screen:
by time of availability along a first axis, and
by source along a second axis distinct from the first axis,
and wherein the apparent dimensions of the thumbnails are equal and independent of the content duration.

2. The method according to claim 1, wherein the thumbnails are distributed within a matrix in which each cell comprises a thumbnail and in which a fixed position row/column in the matrix contains thumbnails for content available at a reference time via the different sources represented in the matrix.

3. The method according to claim 2, wherein the device comprises a means for modifying said reference time, and, when said reference time is modified by a command from the user, the device orders the thumbnails of the matrix to be updated such that said fixed position row/column comprises thumbnails concerning the content broadcast at the modified reference time.

4. The method according to claim 2, wherein the device comprises a means for selecting a thumbnail in the matrix,
and wherein, when another thumbnail is selected by a command from the user, the device orders the reference time to be updated to a time when the content item associated with the newly selected thumbnail is available.

5. The method according to claim 4, wherein, when another thumbnail is selected by a command from a user, the device orders the thumbnails of the matrix to be updated such that said fixed position row/column comprises the newly selected thumbnail and the thumbnails concerning the content items being broadcast at the updated reference time.

6. The method according to claim 2, wherein each matrix element corresponds to a different content item.

7. The method according to claim 2, wherein:
each thumbnail in a row/column preceding the fixed position row/column on the first axis contains information about a content item broadcast before a content item issuing from the same source and for which the thumbnail appears in the fixed position row/column, and
each thumbnail in a row/column following the fixed position row/column on the first axis contains information about a content item broadcast after a content item issuing from the same source and for which the thumbnail appears in the fixed position row/column.

8. The method according to claim 1, wherein the device additionally controls the display of a cursor indicating the thumbnail for a content item being broadcast at the reference time, and wherein:
when ordered by a user, the displayed cursor moves from one thumbnail to another
in order to, when ordered by the user, trigger the display of information about a content item for which the thumbnail is indicated by the cursor.

9. The method according to claim 8, wherein the thumbnails are distributed within a matrix in which each cell comprises a thumbnail and in which a fixed position row/column in the matrix contains thumbnails for content available at a reference time via the different sources represented in the matrix,
and wherein the device controls the display, outside the matrix, of additional information about the content item for which the thumbnail is indicated by the cursor, from among at least a broadcast start time for the content item, a duration for the content item, and a description of the content item.

10. The method according to claim 1, in which at least a portion of said content corresponds to television programs,
wherein at least a portion of the thumbnails comprises content images, and wherein the device accesses:
data providing previews of television programs in order to obtain at least a portion of said images in the form of animated images, at least for content currently being broadcast, and
metadata specific to each content item in order to obtain at least a portion of said images in the form of fixed images, at least for content scheduled to be broadcast in the future.

11. The method according to claim 1, wherein the device additionally manages the display of a menu for selecting the type of content, in order to display on said first and second axes the content items of a selected type, when commanded by the user.

12. The method according to claim 1, wherein the device is arranged to:
select content according to at least one criterion, and
manage the display of thumbnails in the matrix by displaying the selected content differently than the unselected content.

13. The method according to claim 12, wherein the device manages the display of thumbnails to show less detailed information for the unselected content than for the selected content.

14. A non-transitory computer-readable storage medium comprising instruction code for implementing the method according to claim 1, when said program is executed by a processor.

15. A device comprising a means for processing data in order to display thumbnails, upon receiving a command from a user, containing information concerning multimedia content having respective durations and available via a plurality of respective sources and at respective times, said thumbnails being distributed across a screen:
by time of availability along a first axis, and
by source along a second axis distinct from the first axis,
wherein the apparent dimensions of the displayed thumbnails are equal and independent of the content duration.

16. A system comprising:
a device comprising a display screen, and
a device comprising a means for processing data in order to display thumbnails, upon receiving a command from a user, containing information concerning multimedia content having respective durations and available via a plurality of respective sources and at respective times, said thumbnails being distributed across the screen:
by time of availability along a first axis, and
by source along a second axis distinct from the first axis,
wherein the apparent dimensions of the displayed thumbnails are equal and independent of the content duration.
